(19) United States
(12) Patent Application Publication
(10) Pub. No.: US 2009/0217353 A1
(43) Pub. Date: Aug. 27, 2009

(54) METHOD, SYSTEM AND DEVICE FOR NETWORK ACCESS CONTROL SUPPORTING QUARANTINE MODE

(76) Inventor: Xiongkai ZHENG, Beijing (CN)

Correspondence Address: LADAS & PARRY LLP, 224 SOUTH MICHIGAN AVENUE, SUITE 1600, CHICAGO, IL, 60604, US

(21) Appl. No.: 12/390,541

(22) Filed: Feb. 23, 2009

(30) Foreign Application Priority Data
Feb. 26, 2008 (CN) 200810100935.1

(51) Int. Cl. H04L 9/32; G06F 17/00

(52) U.S. Cl. 726/3; 726/1; 707/100

(57) ABSTRACT

This invention discloses a network access control method supporting quarantine mode. Access devices can identify access control strategies identifications of which are returned from the AAA server during identity authentication processes. When the security policy server needs to assign an access control strategy to the access device for the terminal, the AAA server puts the identification of the required access control strategy into the identity authentication response to be sent to the access device, and then the access device recognizes and applies the access control strategy. Thus access devices from any vendors can cooperate with the security policy server in quarantine mode. This invention also discloses a network access control system supporting quarantine mode, and the system consists at least of a security policy server, an AAA server, and some user terminals.

### FIELD OF THE INVENTION

This invention relates in general to the field of network access and more particularly to a network access control method and system that support the quarantine mode. The network access control system includes a security policy sever, an AAA server, and user terminals.

### BACKGROUND OF THE INVENTION

With the popularity of network applications, network security has become a big concern of enterprises, and network access control solutions have been developed to answer the security requirements. Such a solution is implemented through a network system comprising these types of components: the security policy server, AAA server, access device, and terminal. With such a solution, after a terminal passes identity authentication, the access device allows the terminal to access only the specified network resources, which are referred to as the quarantined area. A terminal can repair its system in the quarantined area. The security policy server will check the security status of the terminal. If the terminal passes the security checking, it can then access other network resources. This guarantees the security of the terminal and the internal network.

FIG. 1 is the flow chart of the existing network access control solutions.

In step 101, the terminal sends an identity authentication request to the access device.

In step 102, the access device sends the identity authentication request of the terminal to the AAA server.

In step 103, the AAA server authenticates the terminal and, after the terminal passes the identity authentication, sends the identification of a quarantine access control list (ACL) for the terminal to the access device. As a common practice in the industry, encapsulating, sending or carrying an ACL means encapsulating, sending or carrying the number or name of the ACL.

In step 104, the access device obtains the corresponding quarantine ACL according to the identification of the quarantine ACL received, and applies the obtained quarantine ACL.

In step 105, the access device notifies the terminal of the identity authentication success.

Now, the access device allows the terminal to access only the quarantined area. Usually, in a quarantined area are a third-party antivirus server and a patch server. A terminal can access the quarantined area to, for example, upgrade its software and search for and clear viruses on its system, getting ready for security checking by the security policy server. Of course, a terminal can also choose not to access the servers in the quarantined area.

In step 106, after receiving the identity authentication success notification, the terminal sends a security checking request to the security policy server.

In step 107, the security policy server receives the security checking request of the terminal and notifies the terminal of the security checking items in response.

In step 108, the terminal performs security checking as required and reports the result to the security policy server.

In step 109, the security policy server checks the security checking result of the terminal to see whether the terminal satisfies the security requirements. If yes, it delivers the identification of a security ACL to the access device, and sends a security checking success notification to the terminal; otherwise, it sends a security checking failure notification to the terminal along the dashed line shown in FIG. 1.

In step 110, the access device obtains the corresponding security ACL according to the identification of the security ACL received, and applies the obtained security ACL.

After receiving the security checking success notification from the security policy server, the terminal can access the network resources specified by the security ACL.

Currently, most enterprises need to deploy network access control solutions on their existing networks, on which reside devices from different vendors. As identity authentication is involved, the present network access control solutions usually use the Remote Authentication Dial In User Service (RADIUS) protocol for interaction between the terminal and access device and between the access device and AAA server. Most devices support RADIUS. However, there is no standard or protocol for interaction between the access device and security policy server and between the terminal and security policy server. As a result, vendors define their own proprietary protocols to meet the need. Thanks to the openness of the terminal systems, changes can be made to terminals during deployment of such a network access control solution so that the terminals can interact with the security policy server. The situation for access devices from different vendors, nevertheless, is completely different because it is practically impossible to enable those access devices to interact with the security policy server by making changes to their proprietary protocols.

Without enabling access devices to cooperate with the security policy server, network access control solutions cannot implement access control while protecting enterprises' existing investment.

### SUMMARY

The present invention provides a network access control method, network access control system, security policy server system, terminal system, and AAA server system that support the quarantine mode, allowing interaction between access devices from different vendors and the security policy server and thus implementing network access control in quarantine mode.

To support interaction between access devices and the security policy server, the present invention implements:

A network access control method that supports quarantine mode on a network including one or more user terminals, a security policy server for terminal security checking, and an AAA server for terminal identity authentication, the method includes:

the security policy server sending to a terminal indication information of an access control strategy when it has need of assigning the access control strategy corresponding to a security checking result for the terminal;

the terminal, upon receiving the indication information, sending to the AAA server an identity authentication request that carries the indication information;

the AAA server processing the identity authentication request, and instructing an access device to apply the access control strategy according to the indication information carried in the identity authentication request.

A network access control system that supports quarantine mode includes: one or more user terminals, a security policy server for terminal security checking, and an AAA server for terminal identity authentication; and

the security policy server is used for sending to the terminal indication information of an access control strategy when it needs to assign the access control strategy corresponding to a security checking result for the terminal;

the terminal is used for sending, upon receiving the indication information, to the AAA server an identity authentication request that carries the indication information;

the AAA server is used for processing the received identity authentication request, and instructing an access device to apply the access control strategy according to the indication information carried in the identity authentication request.

A security policy server that supports quarantine mode on a network including one or more user terminals and an AAA server for terminal identity authentication, wherein

the security policy server is used for terminal security checking, and includes an execution unit and a transceiver unit;

the execution unit is used to send through the transceiver unit to the terminal indication information of an access control strategy when the access control strategy corresponding to a security checking result is needed to be assigned for the terminal, for enabling the terminal to send an identity authentication request to the AAA server, wherein the identity authentication request is used to enable the AAA server to send the access control strategy to the access device; and

the transceiver unit is used to send and receive data on behalf of the execution unit.

A user terminal that supports quarantine mode on a network, the network including a security policy server for terminal security checking and an AAA server for terminal identity authentication; wherein

the user terminal includes a processing unit and a transceiver unit;

the processing unit is used to receive through the transceiver unit indication information of an access control strategy from the security policy server, and send to the AAA server an identity authentication request carrying the indication information of the access control strategy in response, so as to drive the AAA server to assign the access control strategy to an access device with which it is connected;

the transceiver unit is used to send and receive data on behalf of the processing unit.

An AAA server that supports quarantine mode on a network, the network including one or more user terminals and a security policy server for terminal security checking; wherein

the AAA server is used for terminal identity authentication, and includes a control unit and a transceiver unit;

the control unit is used to receive through the transceiver unit an identity authentication request that carries indication information of an access control strategy sent from a terminal, and instruct the access device to apply the access control strategy identified by the indication information through the transceiver unit;

the transceiver unit is used to send and receive data on behalf of the control unit.

The present invention is based on recognition of this fact: all access devices can identify the identification of an access control strategy that the AAA server returns during identity authentication. By making a terminal initiate an identity authentication process to the AAA server when the security policy server needs to assign an access control strategy for the terminal, and allowing the AAA server to return the identification of the access control strategy to the access device, the present invention enables the access device to obtain the access control strategy according to the identification of the access control strategy and apply the access control strategy. Thus, access devices from any vendors can cooperate with the security policy server in quarantine mode, implementing network access control in quarantine mode.

### BRIEF DESCRIPTION OF THE DRAWINGS

FIG. 1 is the flow chart of existing network access control solutions.

FIG. 2 is the flow chart of the method used by the present invention.

FIG. 3 is the block diagram of a system using the present invention.

FIG. 4 is the flow chart of embodiment 1 for the present invention.

FIG. 5 is the block diagram of embodiment 1 for the present invention.

FIG. 6 is the block diagram of the security policy server in embodiment 1 of the present invention.

FIG. 7 is the block diagram of the terminal in embodiment 1 of the present invention.

FIG. 8 is the block diagram of the AAA server in embodiment 1 of the present invention.

FIG. 9 is the flow chart of embodiment 2 for the present invention.

### EMBODIMENTS OF THE INVENTION

From the previous analysis of the existing network access control solutions, you can see that these solutions have a sticking point, that is, they cannot make access devices from different vendors identify identifications of ACLs delivered by the security policy server. Accordingly, the ACLs can not be used on the access devices, and the existing network access control solutions are therefore unable to be carried out.

Considering that all access devices can identify the identifications of ACLs that the AAA server returns during identity authentication, the present invention enables the AAA server to return the identification of an ACL that the security policy server needs to assign to an access device. Thus, access devices from different vendors can cooperate with the security policy server in quarantine mode.

The technical schemes provided in embodiments of the present invention are applicable not only in a scenario that an ACL is used as an access control strategy, but also in a scenario that assigning VLANs for terminals is used as an access control strategy. In the case of assigning VLANs for terminals, the VLANs assigned for terminals are classified as security VLAN and quarantine VLAN, and terminals are restricted to access the VLAN under the control of the setting of VLAN access attribute.

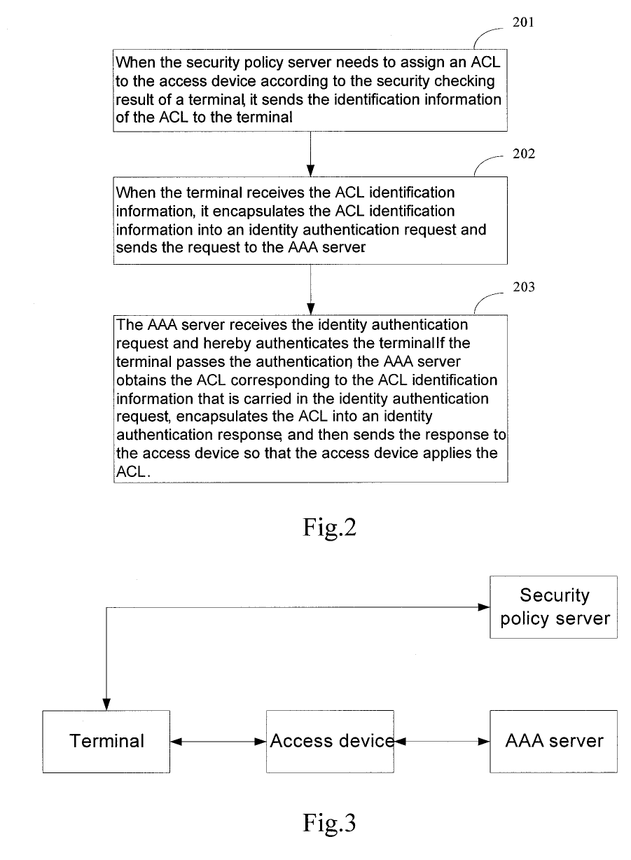

FIG. 2 is the flow chart of the method used by the present invention. A network using the present invention contains at least a security policy server for terminal security checking, an AAA server for identity authentication, and some user terminals, which cooperate in three steps:

In step 201, when the security policy server needs to assign an access control strategy for a terminal according to a security checking result of the terminal, it sends indication information of the access control strategy to the terminal.

In step 202, when the terminal receives the indication information of the ACL, it encapsulates the indication information of the ACL into an identity authentication request and sends the request to the AAA server.

In step 203, the AAA server processes the received identity authentication request, and instructs the access device to apply the ACL according to the indication information of the ACL carried in the identity authentication request. In step 203, the AAA server authenticates the terminal upon receiving the identity authentication request, and obtains an identification of the access control strategy according to the indication information of the corresponding access control strategy after the terminal has passed the authentication, and encapsulates the identification into an identity authentication response and sends the identity authentication response to the access device, so that the access device can use the access control strategy for access control.

Here, the process of assigning the access control strategy corresponding to a security checking result for the terminal may be assigning a VLAN corresponding to the security checking result for the terminal; or, delivering an access control list (ACL) corresponding to the security checking result to the access device for the terminal.

FIG. 3 is the block diagram of a system using the present invention. As shown in the figure, the system comprises at least a security policy server for terminal security checking, an AAA server for identity authentication, and some user terminals, wherein:

the security policy server, when needing to assign an access control strategy for a terminal corresponding to the security checking result of the terminal, sends the indication information of the access control strategy to the terminal;

the terminal, after receiving the indication information of the access control strategy, sends to the AAA server an identity authentication request carrying the indication information;

the AAA server receives the identity authentication request carrying the indication information of the access control strategy sent from the terminal, processes the received identity authentication request, and instructs an access device to apply the access control strategy according to the indication information carried in the identity authentication request. Here, the AAA server is used for authenticating the terminal upon receiving the identity authentication request, obtaining an identification of the access control strategy according to the indication information after the terminal has passed the authentication, and sending to the access device an identity authentication response carrying the identification, so that the access device can use the access control strategy for access control of the terminal.

The security policy server is used for assigning a VLAN corresponding to the security checking result for the terminal; or, the security policy server is used for delivering an access control list (ACL) corresponding to the security checking result to the access device for the terminal.

When the security policy server delivers the ACL to the access device for the terminal, the indication information can be used to indicate the type of the ACL delivered to the AAA server, or an identification of the ACL. In the case that the indication information is the type of the ACL delivered, the AAA server obtains, when processing the identity authentication request, the identification of the ACL from security policies of the terminal according to the type of the ACL, wherein the type of the ACL is used as the indication information. The security policies may be set by a network administrator when the terminal logs in the network, and the security policies are configured with identifications of security ACL and quarantine ACL applicable to the terminal. When the AAA server receives the type of the ACL to be applied on the terminal, it can search the security policies for the corresponding identification of the ACL.

When the indication information is an identification of the ACL, the security policy server obtains the identification of the ACL from the security policies of the terminal when it has need of providing the ACL to the access device, and sends the obtained identification of the ACL to the terminal. That is, when the security policy server needs to assign the identification of a security ACL to the access device, it obtains the corresponding identification of the security ACL from the security policies of the terminal; when the security policy server needs to assign the identification of a quarantine ACL to the access device, it obtains the corresponding identification of the quarantine ACL from the security policies of the terminal.

If the access device is already using an ACL (called the first ACL) for the terminal but the security policy server needs to assign another ACL (called the second ACL) for the terminal to the access device, the terminal will sends a logoff request to the server when it receives the indication information of the second ACL. When the AAA server receives the logoff request, it processes the request and sends a logoff success notification to the terminal through the access device. When the access device receives the notification, it cancels the application of the first ACL. Meanwhile, when the terminal receives the notification, it sends to the AAA server an identity authentication request that carries the ACL indication information of the second ACL. Then, the AAA server will return to the access device an identification authentication response that carries the indication information of the second ACL, so that the access device can use the second ACL for access control of the terminal.

The first ACL can be the quarantine ACL, and the second can be the security ACL. This is true when the access device first quarantines the terminal based on the quarantine ACL and then the terminal passes security checking and the security policy server assigns a security ACL for the terminal to the access device. The first ACL may also be the security ACL, and the second ACL may be the quarantine ACL accordingly. This is true when the access device uses the security ACL to permit the terminal to access the network before security checking is performed for the terminal. Later, if the terminal passes the security checking, no more ACL needs to be assigned to the access device for the terminal, and the access service efficiency is thus improved. If the terminal fails the security checking, the security policy server needs to assign the quarantine ACL for the terminal to the access device, so as to force the terminal to repair its system by using resources such as the third-party antivirus server and patch server in the quarantined area.

To clarify the aims, technical proposals, and advantages of the present invention, the following part provides further descriptions through two embodiments, and an ACL is set as the access control strategy in the two embodiments. In these two embodiments, the RADIUS protocol is used.

### Embodiment 1

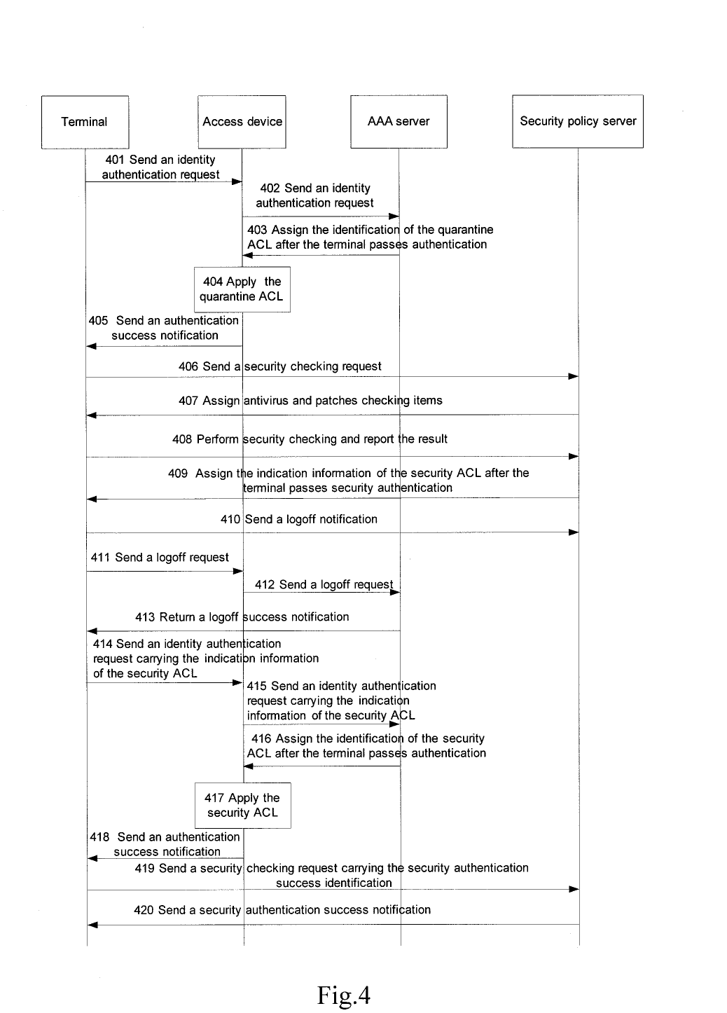

This embodiment mainly describes how the security policy server assigns the security ACL for a terminal to the access device in a scenario where the access device is using the quarantine ACL for the terminal and the terminal passes security checking. FIG. 4 is the flow chart of this embodiment. The following describes the flow chart in details:

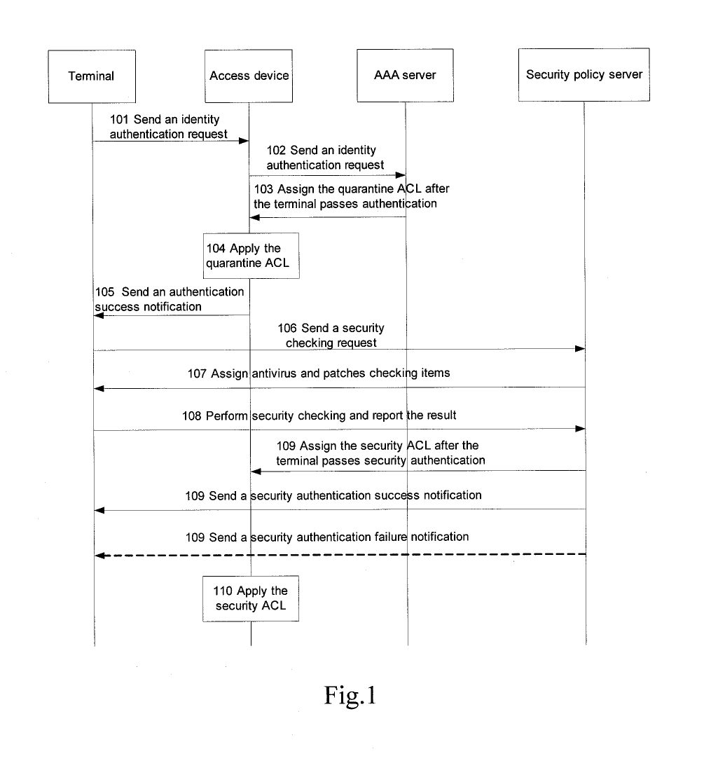

The specific implementation of step 401 to step 408 is the same as that of step 101 to 108 in FIG. 1 and is therefore omitted.

In step 409, the security policy server checks the security checking result to determine whether the terminal is compliant with the security requirements. If yes, it encapsulates the security ACL's indication information in a response packet and sends the packet to the terminal.

Additionally, when the terminal is not compliant with the security requirements, the security policy server sends an authentication failure notification to the terminal. Since the terminal is not in security at present, it has no need to apply a security ACL on the access device for the terminal. Accordingly, it is not required to carry the indication information of the security ACL in the authentication failure notification.

The security policy server can add the ACL attribute into the original authentication success notification packet for carrying the indication information of the ACL. When the identification of the ACL is used to indicate the type of the ACL to be assigned to the access device, the word “security” can be used for representing the security ACL, and the word “quarantine” can be used for representing the quarantine ACL; or using a code for representing the type, such as 0x0609 for security ACL and 0x060A for quarantine ACL. As mentioned above, the indication information of the ACL can be the identification of the ACL. Then, the identification of the ACL is carried in the authentication success notification as the indication information of the ACL.

In step 410, the terminal records the security ACL indication information assigned by the security policy server and sends a logoff notification to the security policy server. When the security policy server receives the logoff notification, it removes all records relevant to the terminal. As security policy server processes logoff notifications independently of ACL configuration, it is not necessary for the terminal to send a logoff notification to the security policy server. Therefore, the logoff notification operation is optional.

In step 411, the terminal sends a logoff request to the access device.

In step 412, the access device sends the logoff request of the terminal to the AAA server.

In step 413, the AAA server processes the logoff request and sends a logoff success notification to the terminal through the access device.

When the access device receives the logoff success notification, it removes the application of the quarantine ACL and disables the corresponding port.

In step 414, the terminal sends to the access device an identity authentication request that carries the indication information of the security ACL assigned by the security policy server.

The present invention extends the USER-NAME attribute of the identity authentication request, making it carry the indication information of the security ACL.

In step 415, the access device sends the identity authentication request of the terminal to the AAA server.

In step 416, the AAA server processes the received identity authentication request. If the terminal passes the authentication, the AAA server obtains the identification of the security ACL according to the security ACL indication information carried in the request, encapsulates the identification of the security ACL into the identity authentication response, and sends the response to the access device.

One of specific implementations for the AAA server to obtain the identification of the ACL according to the indication information of the ACL includes: the AAA server obtains the identification of the ACL from security policies of the terminal according to the type of the ACL when the indication information is adapted to indicate to the AAA server the type of the delivered ACL. In another example when the identification of the ACL is set as the indication information, the AAA server sends the identification of the ACL as the indication information to the access device, for instructing the access device to apply the corresponding ACL.

The database for storing the security policies of the terminal is a database of the AAA server, or a database of the security policy server, or a database shared by the AAA server and the security policy server.

In step 417, the access device applies the security ACL corresponding to the identification of the security ACL.

In step 418, the access device notifies the terminal of the identity authentication success.

In step 419, the terminal sends to the security policy server a security checking request that carries a security checking success identification, which indicates that the terminal has passed security checking and there is no need to check its security again. With this identification, the security policy server will return a security checking success notification directly. Support for the security checking success identification can be implemented by adding an attribute with the value of true in the security checking request packet.

In step 420, when the security policy server receives the security checking request, it finds the security checking success identification and directly sends a security checking success notification to the terminal.

In step 401 of the above mentioned process, the terminal sends the identity authentication request to the access device, and the access device constructs a RADIUS-based identity authentication request, and sends the RADIUS-based identity authentication request to the AAA server. Thereafter, the AAA server and the access device perform identity authentication for the terminal based on the RADIUS protocol, wherein the identity authentication relates mainly to steps 402, 403, 415 and 416. Further, the interaction between the terminal and the access device for performing identity authentication for the terminal is based on the 802.1X protocol.

Now, the terminal can access the network resources specified by the security ACL.

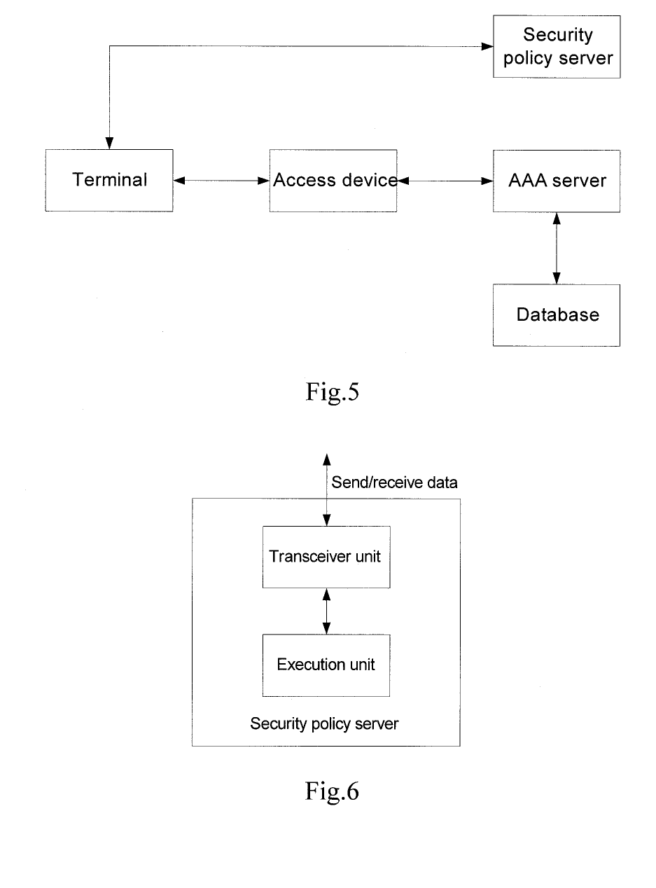

The following paragraphs describe the system architecture of this embodiment. FIG. 5 is the block diagram of this embodiment. As shown in the figure, the system includes five components: security policy server, terminal, AAA server, database, and access device, wherein:

Security policy server: When the access device is using the quarantine ACL for the terminal and the terminal passes security checking, the security policy server sends to the terminal the indication information of the security ACL that is to be assigned to the access device for the terminal. Later, upon receiving the security checking request that carries the security checking success identification from the terminal, the security policy server sends a security checking success notification to the terminal directly through the transceiver unit.

Concretely, the security policy server includes an execution unit and a transceiver unit, as shown in FIG. 6, wherein: the execution unit is used to send through the transceiver unit to a terminal the indication information of the security ACL in a scenario where the access device is using the quarantine ACL for the terminal and the terminal passes the security checking; the transceiver unit is used to send and receive data on behalf of the execution unit.

The execution unit is used to search the security policies preserved in the database and obtain an identification of the ACL corresponding to the terminal, and deliver the identification of the ACL as the indication information of the ACL to the terminal when providing to the access device the ACL corresponding to the security checking result in the case that the indication information is an identification of the ACL. Here, the database is used for preserving security policies of one or more terminals, wherein identifications of security ACL and quarantine ACL applicable to the one or more terminals are configured in the security policies. Or, the execution unit is used to deliver the type of the ACL to the terminal through the transceiver unit when providing to the access device the ACL corresponding to the security checking result in the case that the indication information is for indicating the type of the ACL delivered. In addition, upon receiving the security checking request that carries the security checking success identification from the terminal, the execution unit sends a security checking success notification to the terminal directly through the transceiver unit. The database can reside on the security policy server, or can be a database shared by the AAA server and the security policy server.

Terminal: Sends a logoff request to the AAA server after receiving the indication information of the security ACL, and sends an identity authentication request carrying the indication information of the security ACL to the AAA server after receiving the logoff success notification returned from the AAA server.

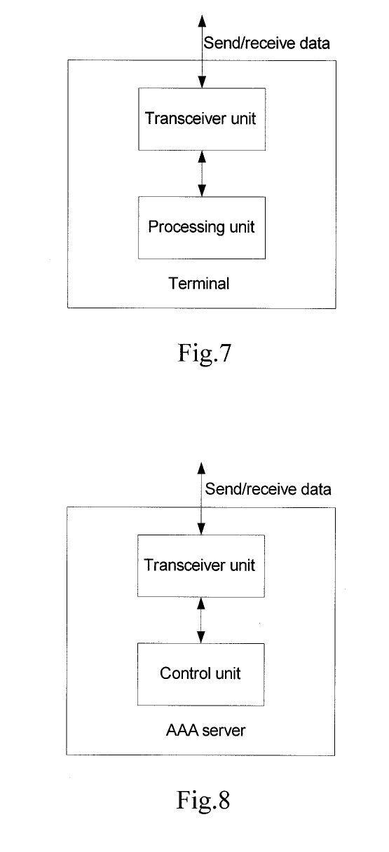

Concretely, the terminal includes a processing unit and a transceiver unit, as shown in FIG. 7. Using the transceiver unit, the processing unit receives the indication information of the security ACL from the security policy server and, in response, sends to the AAA server an identity authentication request carrying the indication information of the security ACL, so as to drive the AAA server to assign the security ACL to the access device with which it is connected. The transceiver unit is used to send and receive data on behalf of the processing unit.

The processing unit, with the help of the transceiving capability of the transceiver unit, is further used to: send a logoff request to the AAA server after receiving the indication information of the security ACL assigned by the security policy server, send an identity authentication request to the AAA server after receiving the logoff success notification returned by the AAA server. Further, the processing unit sends to the security policy server a security checking request that carries the security ACL indication information after receiving the identity authentication success notification sent from the security policy server carrying the indication information of the security ACL.

In addition, with the help of the transceiver unit, the processing unit is also used to send via the access device to the AAA server the RADIUS-based identity authentication request that carries the security ACL indication information in the USER-NAME attribute.

AAA server: Processes each received logoff request and sends a logoff success notification to the terminal through the access device in response; receives and processes the identity authentication request from the terminal that carries the security ACL indication information; after the terminal passes identity authentication, looks up the database for the identification of the security ACL corresponding to the indication information; encapsulates the obtained identification of the security ACL in the identity authentication response and sends the response to the access device.

Concretely, the AAA server consists of a control unit and a transceiver unit, as shown in FIG. 8.

The control unit, with the help of the transceiver unit, receives each logoff request and sends a logoff success notification to the terminal through the access device in response; receives and processes the identity authentication request from the terminal that carries the security ACL indication information; after the terminal passes identity authentication, obtains the identification of the security ACL identified by the indication information; encapsulates the obtained identification of the security ACL in the identity authentication response and sends the packet to the access device. The transceiver unit is used to send and receive data on behalf of the control unit.

Additionally, the control unit is used to search security policies preserved in a database when receiving indication information for indicating the type of the ACL, obtain an identification of the ACL corresponding to the terminal according to the type of the ACL, and encapsulate the identification of the ACL into an identity authentication response and send the identity authentication response to the access device through the transceiver unit. Here, the database is used for preserving the security policies of the one or more terminals, and identifications of security ACL and quarantine ACL applicable to the one or more terminals are set in the security policies. Or, the control unit is used to carry the identification of the ACL into an identity authentication response and send it to the access device through the transceiver unit when receiving the identification of the ACL as the indication information. In detail, the control unit sends a RADIUS-based identity authentication response to the access device through the transceiver unit.

The database can reside on the AAA server, security policy server, or can be a database shared by the AAA server and the security policy server.

Access device: Receives the logoff success notification that the AAA server returns for a terminal, removes the application of the quarantine ACL for the terminal, and applies the security ACL after receiving from the AAA server the identity authentication response carrying the identification of the security ACL.

### Embodiment 2

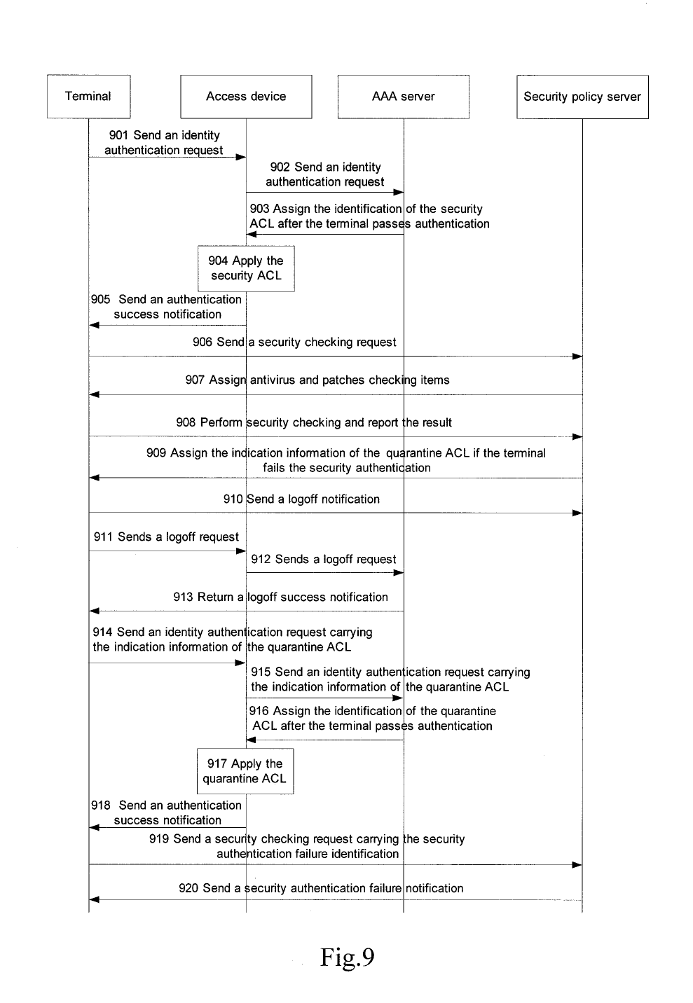

This embodiment mainly describes how the security policy server assigns the quarantine ACL for a terminal to the access device in a scenario where the access device is using the security ACL for a terminal but the terminal fails the security checking. FIG. 9 is the flow chart of this embodiment. The following describes the flow chart in details:

In step 901, the terminal sends an identity authentication request to the access device.

In step 902, the access device sends the identity authentication request of the terminal to the AAA server.

In step 903, the AAA server authenticates the terminal and, after the terminal passes the identity authentication, sends the identification of the security ACL for the terminal to the access device.

In step 904, the access device applies the security ACL corresponding to the identification.

In step 905, the access device notifies the terminal of the identity authentication success.

The specific implementation of step 906 to step 908 is the same as that of step 106 to 108 in FIG. 1 and is therefore not described in detail.

In step 909, the security policy server checks the security checking result to determine whether the terminal is compliant with the security requirements. If not, it encapsulates the quarantine ACL's indication information in a response packet and sends the packet to the terminal.

In addition, when the terminal is compliant with the security requirements, the security policy server sends an authentication success notification to the terminal. Since the terminal is in security at present, the terminal has no need to send an identity authentication to the AAA server for applying a quarantine ACL after receiving the authentication success notification. Accordingly, it is not required to carry the indication information of the quarantine ACL in the authentication success notification which is sent to the terminal by the security policy server.

The security policy server can add the ACL attribute into the original authentication failure notification packet for carrying the indication information of the ACL. One of exemplary specific implementations of the indication information has been illustrated in the technical schemes of Embodiment 1.

In step 910, the terminal records the quarantine ACL indication information assigned by the security policy server and sends a logoff notification to the security policy server.

In step 911, the terminal sends a logoff request to the access device.

In step 912, the access device sends the logoff request of the terminal to the AAA server.

In step 913, the AAA server processes the logoff request and sends a logoff success notification to the terminal through the access device.

When the access device receives the logoff success notification, it removes the application of the security ACL and disables the corresponding port. Then, the terminal cannot access the network resources any more.

In step 914, the terminal sends to the access device an identity authentication request that carries the quarantine ACL's indication information.

Here, the present invention extends the USER-NAME attribute of the identity authentication request, making it carry the indication information of the quarantine ACL. Likewise, an exemplary specific implementation of the indication information has been illustrated in the technical schemes of Embodiment 1.

In step 915, the access device sends the identity authentication request of the terminal to the AAA server.

In step 916, the AAA server processes the received identity authentication request. If the terminal fails the authentication, the AAA server obtains the identification of the quarantine ACL according to the indication information carried in the request, encapsulates the identification into the identity authentication response, and sends the response to the access device.

The way that the AAA server figures out the quarantine ACL is similar to the way that the AAA server figures out the security ACL and is therefore omitted.

In step 917, the access device applies the quarantine ACL corresponding to the received identification of the quarantine ACL.

In step 918, the access device notifies the terminal of the identity authentication success.

In step 919, the terminal sends to the security policy server a security checking request that carries a security checking failure identification, wherein:

The security checking failure identification indicates that the terminal failed the security checking and there is no need to check its security again. With this identification, the security policy server will return a security checking failure notification directly. Support for the security checking failure identification can be implemented by adding an attribute with the value of false in the security checking request packet.

In step 920, when the security policy server receives the security checking request, it finds the security checking failure identification and directly sends a security checking failure notification to the terminal.

After the access device applies the quarantine ACL, the terminal can access only the quarantined area to, for example, upgrade its software. After the terminal system is repaired properly, the terminal sends a security checking request to the security policy server again. For the subsequent steps, refer to the steps from step 406 on in FIG. 4.

In step 901 of the procedure shown in FIG. 9, the terminal sends the identity authentication request to the access device, and the access device constructs a RADIUS-based identity authentication request, and sends the RADIUS-based identity authentication request to the AAA server. Thereafter, the AAA server and the access device perform identity authentication for the terminal based on the RADIUS protocol, wherein the identity authentication relates mainly to steps 902, 903, 915 and 916. Further, the interaction between the terminal and the access device for performing identity authentication for the terminal is based on the 802.1X protocol.

The following paragraphs describe the system architecture of this embodiment, which can be the same as that of embodiment 1 (as shown in FIG. 5).

Security policy server: If the access device is using the security ACL for the terminal but the terminal fails the security checking, the security policy server sends to the terminal the indication information of the quarantine ACL.

Concretely, the security policy consists of an execution unit and a transceiver unit. The structure of the security policy server in this embodiment is the same as that of the security policy server in embodiment 1 (see FIG. 6), wherein the execution unit is used to send through the transceiver unit to the terminal the indication information of the quarantine ACL in a scenario where the access device is using the security ACL but the terminal fails the security checking, and the transceiver unit is used to send and receive data on behalf of the execution unit. Upon receiving the security checking request that carries the security checking failure identification from the terminal, the execution unit sends a security checking failure notification to the terminal directly through the transceiver unit. In addition, an exemplary specific implementation of the indication information has been provided in the technical schemes of Embodiment 1.

Terminal: Sends a logoff request to the AAA server after receiving the quarantine ACL indication information, and sends an identity authentication request carrying the quarantine ACL indication information to the AAA server through the access device after receiving the logoff success notification returned from the AAA server.

Concretely, the terminal consists of a processing unit and a transceiver unit. The structure of the terminal is the same as that of the terminal in embodiment 1 (see FIG. 7), wherein the processing unit receives the quarantine ACL indication information from the security policy server and sends to the AAA server an identity authentication request carrying the quarantine ACL indication information in response through the transceiver unit, so as to drive the AAA server to assign the quarantine ACL to the access device, and the transceiver unit is used to send and receive data on behalf of the processing unit.

The processing unit, with the help of the transceiving capability of the transceiver unit, is further used to: send a logoff request to the AAA server after receiving the quarantine ACL indication information assigned by the security policy server, send an identity authentication request to the AAA server after receiving the logoff success notification returned by the AAA server, and send to the security policy server a security checking request that carries the quarantine ACL indication information when receiving the identity authentication success notification and when receiving the indication information of the quarantine ACL carried in the security checking failure notification sent from the security policy server.

In addition, with the help of the transceiver unit, the processing unit also sends via the access device to the AAA server the RADIUS-based identity authentication request that carries the ACL indication information in the USER-NAME attribute.

AAA server: Processes each received logoff request and sends a logoff success notification to the terminal through the access device in response; receives and processes the identity authentication request from the terminal that carries the quarantine ACL indication information; after the terminal passes identity authentication, looks up the database according to the indication information of the quarantine ACL for the corresponding identification of the ACL; encapsulates the obtained identification of the quarantine ACL in the identity authentication response and sends the response to the access device.

Concretely, the AAA server consists of a control unit and a transceiver unit. The structure of the AAA server is the same as that of the AAA server in embodiment 1 (see FIG. 8), wherein the control unit, with the help of the transceiver unit, receives each logoff request and sends a logoff success notification to the terminal through the access device in response; receives and processes the identity authentication request from the terminal that carries the quarantine ACL indication information; after the terminal passes identity authentication, looks up the database for the identification of the quarantine ACL corresponding to the indication information; encapsulates the obtained identification of the quarantine ACL in the identity authentication response and sends the packet to the access device. The transceiver unit is used to send and receive data on behalf of the control unit. Here, the processing on the indication information in different cases is similar to that presented in Embodiment 1, and is not described in detail.

In detail, the control unit sends a RADIUS-based identity authentication response to the access device through the transceiver unit.

Access device: Receives the logoff success notification that the AAA server returns for a terminal, removes the application of the security ACL for the terminal, and applies the quarantine ACL after receiving from the AAA server the identity authentication response carrying the identification of the quarantine ACL.

The present invention is based on recognition of this fact: all access devices can identify the identification of the ACL carried in an identity authentication response that the AAA server returns during identity authentication. By making a terminal initiates an identity authentication when the security policy server needs to assign an ACL to the access device for the terminal, and allowing the AAA server to put the identification of the required ACL into the identity authentication response to be sent to the access device, the present invention enables the access device to recognize and apply the ACL. Thus, access devices from any vendors can cooperate with the security policy server in quarantine mode, implementing network access control in quarantine mode.

Moreover, the above mentioned technical schemes using an ACL as the access control strategy are also practicable in the case when assigning a VLAN for a terminal is set as the access control strategy, wherein, in the latter case, the indication information may correspond to the VLAN, and the identification is also an identification corresponding to the VLAN.

Accordingly, as shown in FIG. 6, the security policy server comprises an execution unit and a transceiver unit. The execution unit is used to send through the transceiver unit to the terminal indication information of an access control strategy when the access control strategy corresponding to a security checking result is needed to be assigned for the terminal, for enabling the terminal to send an identity authentication request to the AAA server, wherein the identity authentication request is used to enable the AAA server to send the access control strategy to the access device; and the transceiver unit is used to send and receive data on behalf of the execution unit. Here, the execution unit is used to assign a VLAN corresponding to the security checking result for the terminal; or, the execution unit is used to deliver an access control list (ACL) corresponding to the security checking result to the access device for the terminal.

As shown in FIG. 7, the user terminal includes a processing unit and a transceiver unit. The processing unit is used to receive through the transceiver unit indication information of an access control strategy from the security policy server, and send to the AAA server an identity authentication request carrying the indication information of the access control strategy in response, so as to drive the AAA server to assign the access control strategy to an access device with which it is connected; the transceiver unit is used to send and receive data on behalf of the processing unit. Here, the indication information of the access control strategy received by the processing unit is a VLAN corresponding to the security checking result assigned by the security policy server for the terminal; or, the indication information of the access control strategy received by the processing unit is indication information of an access control list (ACL) corresponding to the security checking result assigned by the security policy server for the terminal.

As shown in FIG. 8, the AAA server includes a control unit and a transceiver unit. The control unit is used to receive through the transceiver unit an identity authentication request that carries indication information of an access control strategy sent from a terminal, and obtain an identification of the access control strategy according to the indication information carried in the identity authentication request after the terminal passes the identity authentication, and send an identity authentication response carrying the identification to the access device through the transceiver unit; the transceiver unit is used to send and receive data on behalf of the control unit. Here, the identity authentication request received by the control unit sent from the terminal comprises indication information of a VLAN; or, the identity authentication request received by the control unit sent from the terminal comprises indication information of an access control list (ACL).

The present invention can be deployed easily on any existing network without any big changes, protecting the current investment and facilitating network management to the full extent.

Although several embodiments of the invention and their advantages are described in detail, a person skilled in the art could make various alternations, additions, and omissions without departing from the spirit and scope of the present invention as defined by the appended claims.

1. A network access control method that supports quarantine mode on a network including one or more user terminals, a security policy server for terminal security checking, and an AAA server for terminal identity authentication, the method comprising:
the security policy server sending to a terminal indication information of an access control strategy when it has need of assigning the access control strategy corresponding to a security checking result for the terminal;
the terminal, upon receiving the indication information, sending to the AAA server an identity authentication request that carries the indication information;
the AAA server processing the identity authentication request, and instructing an access device to apply the access control strategy according to the indication information carried in the identity authentication request.

2. The method of claim 1, wherein the AAA server processing the identity authentication request, and instructing an access device to apply the access control strategy according to the indication information comprises:
the AAA server authenticating the terminal upon receiving the identity authentication request; and
after the terminal passing the authentication, the AAA server obtaining an identification of the access control strategy according to the indication information, and sending an identity authentication response carrying the identification to the access device, so that the access device can use the access control strategy for access control of the terminal.

3. The method of claim 2, wherein assigning the access control strategy corresponding to a security checking result for the terminal comprises:
assigning a VLAN corresponding to the security checking result for the terminal.

4. The method of claim 2, wherein assigning the access control strategy corresponding to a security checking result for the terminal comprises:
delivering an access control list (ACL) corresponding to the security checking result to the access device for the terminal.

5. The method of claim 4, wherein the indication information is adapted to indicate the type of the ACL delivered to the access device; and
the AAA server obtaining an identification of the access control strategy according to the indication information comprises:
the AAA server obtaining the identification of the ACL from security policies of the terminal according to the type of the ACL, wherein identifications of security ACL and quarantine ACL applicable to the terminal are configured in the security policies.

6. The method of claim 4, wherein the indication information is an identification of the ACL; and
the security policy server sending to a terminal indication information of an access control strategy when it has need of assigning the access control strategy corresponding to a security checking result for the terminal comprises:
the security policy server obtaining the identification of the ACL according to the security policies of the terminal when it has need of providing the ACL to the access device, and sending the obtained identification of the ACL to the terminal, wherein identifications of security ACL and quarantine ACL applicable to the terminal are configured in the security policies.

7. The method of claim 5, wherein the security policies of the terminal are stored in a database, wherein the database is a database of the AAA server, or a database of the security policy server, or a database shared by the AAA server and the security policy server.

8. The method of claim 4, further comprising:
when the access device has already applied a first ACL for the terminal, and the security policy server needs to assign to the access device a second ACL for the terminal, performing a process after the terminal receives the indication information of the second ACL and before the terminal sends an identity authentication request to the AAA server, the process including:
the terminal sending a logoff request to the AAA server;
the AAA server processing the logoff request and sending a logoff success notification to the terminal through the access device; and
the access device canceling the application of the first ACL after receiving the logoff success notification.

9. The method of claim 8, comprising:
the security policy server sending the indication information of a security ACL to the terminal when the security policy server needs to assign to the access device the security ACL for the terminal after the terminal has passed the security checking and when the access device has already applied a quarantine ACL for the terminal.

10. The method of claim 9, further comprising:
the terminal, upon receiving an authentication success notification sent from the access device applying the security ACL, sending to the security policy server a security checking request that carries a security checking success identification; and
the security policy server directly sending a security checking success notification to the terminal when determining that the security checking request received includes the security checking success identification.

11. The method of claim 8, comprising:
the security policy server sending the indication information of the quarantine ACL to the terminal when the security policy server needs to assign to the access device a quarantine ACL for the terminal after the terminal has failed to pass the security checking and when the access device has already applied a security ACL for the terminal.

12. The method of claim 11, further comprising:
the terminal, upon receiving an authentication success notification sent from the access device applying the quarantine ACL, sending to the security policy server a security checking request that carries a security checking failure identification; and
the security policy server directly sending a security checking failure notification to the terminal when determining that the security checking request received includes the security checking failure identification.

13. The method of claim 2, wherein the terminal, upon receiving the indication information, sending to the AAA server an identity authentication request comprises:
the terminal sending the identity authentication request based on an RADIUS protocol to the AAA server through the access device; and
the AAA server and the access device performing identity authentication for the terminal based on the RADIUS protocol.

14. The method of claim 13, wherein the identity authentication request sent by the terminal carries the indication information of the ACL in the USER-NAME attribute.

15. A network access control system that supports quarantine mode, comprising:
one or more user terminals, a security policy server for terminal security checking, and an AAA server for terminal identity authentication; and
the security policy server is used for sending to the terminal indication information of an access control strategy when it needs to assign the access control strategy corresponding to a security checking result for the terminal;
the terminal is used for sending, upon receiving the indication information, to the AAA server an identity authentication request that carries the indication information;
the AAA server is used for processing the received identity authentication request, and instructing an access device to apply the access control strategy according to the indication information carried in the identity authentication request.

16. The system of claim 15, wherein the AAA server is used for authenticating the terminal upon receiving the identity authentication request, obtaining an identification of the access control strategy according to the indication information after the terminal has passed the authentication, and sending to the access device an identity authentication response carrying the identification, so that the access device can use the access control strategy for access control of the terminal.

17. The system of claim 16, wherein the terminal is used for sending a logoff request to the AAA server when the access device has already applied a first ACL for the terminal and the terminal receives indication information of a second ACL, and sending an identity authentication request to the AAA server after receiving a logoff success notification from the AAA server;
the AAA server is used for processing the logoff request and sending the logoff success notification to the terminal through the access device;
the access device is used for canceling the application of the first ACL for the terminal after receiving the notification.

18. A security policy server that supports quarantine mode on a network including one or more user terminals and an AAA server for terminal identity authentication, wherein
the security policy server is used for terminal security checking, and comprises an execution unit and a transceiver unit;
the execution unit is used to send through the transceiver unit to the terminal indication information of an access control strategy when the access control strategy corresponding to a security checking result is needed to be assigned for the terminal, for enabling the terminal to send an identity authentication request to the AAA server, wherein the identity authentication request is used to enable the AAA server to send the access control strategy to the access device; and
the transceiver unit is used to send and receive data on behalf of the execution unit.

19. The security policy server of claim 18, wherein the execution unit is used to assign a VLAN corresponding to the security checking result for the terminal.

20. The security policy server of claim 18, wherein the execution unit is used to deliver an access control list (ACL) corresponding to the security checking result to the access device for the terminal.

21. The security policy server of claim 20, wherein
the execution unit is used to send through the transceiver unit to the terminal the indication information of a security ACL when the security ACL is needed to be assigned to the access device for the terminal after the terminal has passed the security check and when the access device has already applied a quarantine ACL for the terminal, so as to drive the terminal to send an identity authentication request to the AAA server.

22. The security policy server of claim 21, wherein
the execution unit is further used to send a security checking success notification to the terminal directly through the transceiver unit upon receiving from the terminal the security checking request that carries the security checking success identification.

23. The security policy server of claim 20, wherein
the execution unit is used to send through the transceiver unit to the terminal indication information of a quarantine ACL when the quarantine ACL is needed to be assigned to the access device for the terminal after the terminal has failed to pass the security check and the access device has already applied a security ACL for the terminal, so as to drive the terminal to send an identity authentication request to the AAA server.

24. The security policy server of claim 23, wherein
the execution unit is used to send a security checking failure notification to the terminal directly through the transceiver unit upon receiving the security checking request that carries the security checking failure identification from the terminal.

25. A user terminal that supports quarantine mode on a network, the network including a security policy server for terminal security checking and an AAA server for terminal identity authentication; wherein
the user terminal includes a processing unit and a transceiver unit;
the processing unit is used to receive through the transceiver unit indication information of an access control strategy from the security policy server, and send to the AAA server an identity authentication request carrying the indication information of the access control strategy in response, so as to drive the AAA server to assign the access control strategy to an access device with which it is connected;
the transceiver unit is used to send and receive data on behalf of the processing unit.

26. The terminal of claim 25, wherein the indication information of the access control strategy received by the processing unit is a VLAN corresponding to the security checking result assigned by the security policy server for the terminal.

27. The terminal of claim 25, wherein the indication information of the access control strategy received by the processing unit is indication information of an access control list (ACL) corresponding to the security checking result assigned by the security policy server for the terminal.

28. The terminal of claim 27, wherein
the processing unit is used to send a logoff request to the AAA server with the help of the transceiver unit after receiving the indication information of the ACL from the security policy server, and send an identity authentication request to the AAA server after receiving the logoff success notification returned from the AAA server.

29. The terminal of claim 28, wherein
the processing unit is used to send through the transceiver unit a security checking request that carries the security checking success identification to the security policy server when receiving the identity authentication success notification and when the security checking success notification returned from the security policy server includes the indication information of the ACL; or
the processing unit is used to send through the transceiver unit a security checking request that carries the security checking failure identification to the security policy server when receiving the identity authentication success notification and when the security checking failure notification returned from the security policy server includes the indication information of the ACL.

30. The terminal of claim 27, wherein
the processing unit is used to send an identity authentication request based on an RADIUS protocol to the AAA server.

31. The terminal of claim 30, wherein
the processing unit is used to encapsulate the indication information of the ACL in the USER-NAME attribute of the identity authentication request.

32. An AAA server that supports quarantine mode on a network, the network including one or more user terminals and a security policy server for terminal security checking; wherein
the AAA server is used for terminal identity authentication, and comprises a control unit and a transceiver unit;
the control unit is used to receive through the transceiver unit an identity authentication request that carries indication information of an access control strategy sent from a terminal, and instruct the access device to apply the access control strategy identified by the indication information through the transceiver unit;
the transceiver unit is used to send and receive data on behalf of the control unit.

33. The AAA server of claim 32, wherein
the control unit is used to process the received identity authentication request, and obtain an identification of the access control strategy according to the indication information carried in the identity authentication request after the terminal passes the identity authentication, and send an identity authentication response carrying the identification to the access device through the transceiver unit.

34. The AAA server of claim 33, wherein the identity authentication request received by the control unit sent from the terminal comprises indication information of a VLAN.

35. The AAA server of claim 33, wherein the identity authentication request received by the control unit sent from the terminal comprises indication information of an access control list (ACL).

36. The AAA server of claim 33, wherein
the control unit is used to send a RADIUS-based identity authentication response to the access device through the transceiver unit.
